(19) United States
(12) Patent Application Publication
(10) Pub. No.: US 2007/0087157 A1
(43) Pub. Date: Apr. 19, 2007

(54) Gasket material

(75) Inventors: Hiroshi Saito, Ikoma-gun (JP); Kenichiro Ishikawa, Ikoma-gun (JP)

Correspondence Address: NIXON & VANDERHYE, PC, 901 NORTH GLEBE ROAD, 11TH FLOOR, ARLINGTON, VA, 22203, US

(73) Assignee: NICHIAS CORPORATION, TOKYO (JP)

(21) Appl. No.: 11/582,518

(22) Filed: Oct. 18, 2006

(30) Foreign Application Priority Data
Oct. 19, 2005 (JP) P.2005-304448

(51) Int. Cl. B32B 15/08; B32B 3/02

(52) U.S. Cl. 428/66.4; 428/457; 428/462

(57) ABSTRACT

The present invention provides a gasket material having: a steel plate; a film containing a reaction product of: (A) a carbonate of at least one selected from the group consisting of Mg, Co, Zr, Mn, Ni, and Cu; (B) a water-dispersible silica; and (C) an organic acid containing at least one of a carboxyl group and a hydroxyl group in one molecule and having 3 to 10 carbon atoms in one molecule; and a rubber layer disposed on at least one side of the steel plate via the film.

### FIELD OF THE INVENTION

The present invention relates to a gasket material for use in engines for outboard motors and automobiles. Mainly, it relates to a gasket material having improved durability against a saline environment.

### BACKGROUND OF THE INVENTION

As a gasket to be mounted on engines for outboard motors and automobiles, a rubber-coated stainless steel plate obtained by laminating a stainless steel plate with a rubber layer is generally used. However, in the case of the engines for outboard motors, seawater is used for cooling the engines and, in the case of engines for automobiles, part of seawater sometimes penetrates into the engine room during seaside running, so that the seawater may be atomized by heat of the engine room and thus the engine room may be filled with mist of the seawater in some cases. Consequently, the seawater filled as mist acts as an electrolyte and a cell reaction occurs between the aluminum flange (anode side) of the engine and the gasket (cathode side), so that the gasket side becomes a highly alkaline environment and thereby adhesion between the rubber layer and the stainless steel plate may be destroyed. Moreover, the adhesion between the rubber layer and the stainless steel plate may be sometimes destroyed also by heat of combustion.

In order to adhere the stainless steel plate to the rubber layer more strongly, there have been widely used a gasket material wherein a chromate film comprising a chromium compound, phosphoric acid, and silica is formed on one side or both sides of the stainless steel plate and the rubber layer is laminated on the chromate film (e.g., see, Reference 1). The chromate film is durable even in a high alkaline environment. Moreover, when a chromate-treating solution is applied on the stainless steel plate, bichromic acid etches the surface of the steel plate to introduce a polar component on the surface of the steel plate, and thus the polar component and the chromate film are strongly adhered via a secondary bond.

[Reference 1] JP-A-3-227622 (e.g., claims, pages. 3-4)

As mentioned above, the gasket material wherein a rubber layer is provided on a stainless steel plate subjected to chromate treatment is excellent in adhesiveness in saline. However, the chromate treatment tends to be avoided since hexavalent chromium contained in the chromate-treating solution adversely affects the human body directly, and a waste solution containing hexavalent chromium should be subjected to special treatment defined in the Water Pollution Control Law. Also, there is a defect that a waste material of the stainless steel material subjected to the chromate treatment cannot be recycled. Furthermore, it is highly probable that chromium in the chromate film may be extracted by the contact with seawater.

### SUMMARY OF THE INVENTION

The invention is conducted in consideration of the influence of the chromate film against the environment and it is an object of the invention to provide a gasket material having durability of adhesion against saline equal to or higher than that of the gasket material subjected to the chromium treatment and also exhibiting no problem in view of environmental aspects.

The present inventors have made eager investigation to examine the problem. As a result, it has been found that the foregoing objects can be achieved by the following gasket materials. With this finding, the present invention is accomplished.

The present invention is mainly directed to the following items:

1. A gasket material comprising: a steel plate; a film comprising a reaction product of: (A) a carbonate of at least one selected from the group consisting of Mg, Co, Zr, Mn, Ni, and Cu; (B) a water-dispersible silica; and (C) an organic acid containing at least one of a carboxyl group and a hydroxyl group in one molecule and having 3 to 10 carbon atoms in one molecule; and a rubber layer disposed on at least one side of the steel plate via the film.

2. The gasket material according to item 1, wherein an amount ratio of the carbonate (A) to the water-dispersible silica (B) is 0.5/9.5 to 9.5/0.5 by weight.

3. The gasket material according to item 1, wherein an amount of the organic acid (C) is 1 to 50% by weight with respect to that of the carbonate (A).

4. The gasket material according to item 1, which further comprises a primer layer between the rubber layer and the film.

5. The gasket material according to item 4, wherein the primer layer comprises an adhesive comprising a nitrile rubber compound and a phenol resin.

Since the gasket material of the invention achieves excellent adhesiveness against saline without subjecting to chromate treatment harmful to the human body, the material exhibits extreme effectiveness and large practical advantages as a measure against social problems such as environmental protection and recycling ability.

### DETAILED DESCRIPTION OF THE INVENTION

The following will describe the invention in detail.

In the gasket material of the invention, a steel plate and a rubber layer are adhered via a film comprising a reaction product of (A) a carbonate at least one selected from the group consisting of Mg, Co, Zr, Mn, Ni, or Cu; (B) a water-dispersible silica; and (C) an organic acid containing at least one of a carboxyl group and a hydroxyl group in one molecule and having 3 to 10 carbon atoms in one molecule, instead of conventional chromate films.

The above metal carbonate (A) is classified into a normal salt and a basic salt. Examples of the normal salt include cobalt carbonate, magnesium carbonate, copper carbonate, nickel carbonate, and manganese carbonate, and examples of the basic salt include basic zinc carbonate, basic cobalt carbonate, basic magnesium carbonate, basic copper carbonate, basic nickel carbonate, basic zirconium carbonate, zirconium ammonium carbonate, basic manganese carbonate, and the like. The metal carbonate (A) for use in the invention is not limited thereto but any of the normal salts and the basic salts can be employed as far as they are carbonates of at least one metal selected from Mg, Co, Zr, Mn, Ni, and Cu. Particularly, a normal salt or basic salt containing Zr as a metal is most effective for saline resistance.

The above water-dispersible silica (B) is preferably one excellent in dispersibility in a treating solution for film formation, and examples as such silica include colloidal silica and vapor-phase silica. The colloidal silica is not particularly limited but Snowtex C, Snowtex N, Snowtex S, Snowtex UP, Snowtex PS-M, Snowtex PS-L, Snowtex 20, Snowtex 30, Snowtex 40 (all manufactured by Nissan Chemical Industries, Ltd.), and the like are commercially available. The vapor-phase silica is not particularly limited but Aerosil 50, Aerosil 130, Aerosil 200, Aerosil 300, Aerosil 380, Aerosil TT600, Aerosil MOX80, Aerosil MOX170 (all manufactured by Nippon Aerosil Co., Ltd.), and the like are commercially available. The water-dispersible silica (B) is preferably blended in a ratio of 5 to 95% by weight, more preferably 10 to 90% by weight, with respect to the above metal carbonate (A).

The above organic acid (C) is not particularly limited as far as it contains at least one of a carboxyl group and a hydroxyl group in one molecule and has 3 to 10 carbon atoms in one molecule. Examples of such an organic acid include citric acid, tartaric acid, tannic acid, adipic acid, glutamic acid, propionic acid, phytic acid, benzoic acid, and the like. Moreover, more preferred range of the number of the carbon atoms is 3 to 8. Furthermore, the content of the organic acid (C) is preferably in the range of 1 to 50% by weight, more preferably 10 to 30% by weight with respect to the above metal carbonate (A).

The steel plate for use in the invention is not particularly limited and stainless steel (such as stainless steel of ferrite-based, martensite-based, or austenite-based), iron, aluminum, and the like can be employed.

An example for the formation of the film on the steel plate is that a treating solution for film formation wherein the above metal carbonate (A), water-dispersible silica (B), and organic acid (C) are dispersed or dissolved in a predetermined ratio is applied on one side or both sides of the steel plate using a general applying means such as a roll coater, followed by drying at a temperature of about 70 to 250° C. In the above formation, during the drying under heating, the metal carbonate (A), water-dispersible silica (B), and organic acid (C) are reacted with one another and the reaction product thereof forms a film. Besides, the amount of the film is not particularly limited but is preferably 50 to 1500 mg/m² from a practical point of view, and the amount to be applied may be suitably adjusted.

Then, on the above film, a rubber layer is formed to accomplish the gasket material of the invention. The rubber for use in the formation of the rubber layer is not particularly limited but is suitably NBR, a fluorocarbon rubber, a silicone rubber, an acrylobutadiene rubber, HNBR, EPDM, or the like, which is excellent in heat resistance and chemical resistance. Moreover, an example for the formation of the rubber layer, it is suitable to apply a rubber solution or latex obtained by dissolving a rubber material in an appropriate solution by means of a skimmer coater or a roll coater so as to be a thickness of 20 to 130 μm, followed by adhesion through vulcanization at a temperature of 150 to 250° C.

Additionally, if necessary, a “primer layer” (e.g., an adhesive of a nitrile rubber compound and a phenol resin) may be present between the rubber layer and the film.

### EXAMPLES

The present invention is now illustrated in greater detail with reference to Examples and Comparative Examples, but it should be understood that the present invention is not to be construed as being limited thereto.

### Preparation of Samples

A treating solution for film formation obtained by mixing components in a ratio shown in Table 1 was applied on both sides of a stainless steel plate by means a roll coater and the coated film was dried at 180° C. to form a film. In this regard, the amount of the film is shown in Table 2. Then, an adhesive composed of a nitrile rubber compound and a phenol resin was applied on the film and the whole was subjected to heat treatment to form a primer layer on the film. Moreover, a sample having no such a primer layer was also prepared (Example 5). Then, a solution obtained by dissolving a nitrile rubber was applied thereon (on the primer layer or the film) by means of a roll coater and the whole was adhered through vulcanization at 180° C. for 10 minutes to form a rubber layer, whereby a sample was prepared.

### Evaluation Method

The samples prepared were evaluated by two methods of (1) a saline immersion test and (2) a cell reaction test to be explained in the following.

(1) Saline Immersion Test

Grid-like cut lines were applied on the surface of the sample at space intervals of2 mm to form 100 squares thereon. Then, the sample was left in a saline solution adjusted so as to be a solid mass concentration of 4% at a solution temperature of 70° C. for 500 hours. Thereafter, the sample was taken out from the 4% saline solution and was subjected to a grid tape-peeling test. The grid tape-peeling test is carried out in accordance with JIS-K5400, wherein a pressure-sensitive adhesive tape was attached on the squares, the pressure-sensitive adhesive tape was completely adhered by rubbing the tape with an eraser, the pressure-sensitive adhesive tape was peeled off in a moment by holding one end of the tape one or two minutes after the tape adhesion, and then remaining number of the squares was determined. The results are represented as (Number of Remaining Squares)/100 and shown in Table 2.

(2) Cell Reaction Test

Grid-like cut lines were applied on the surface of a sample at space intervals of 2 mm to form 100 squares thereon. Then, the sample was left in a saline solution adjusted so as to be a solid mass concentration of 4% at a solution temperature of 70° C. for 168 hours while the sample was connected to an Al plate. Thereafter, the sample was taken out from the 4% saline solution and was subjected to a similar grid tape-peeling test. The results are represented as (Number of Remaining Squares)/100 and shown in Table 2.

TABLE 1
Composition of treating solution for film formation used in Examples
and Comparative Examples

| | | (B) Water-dispersible | | | |
|---|---|---|---|---|---|
| | (A) Carbonate | silica | (C) Organic acid | | |
| | Kind | Kind | Kind | (A)/(B) | (C)/(A) × 100 |
| Example 1 | copper carbonate | colloidal silica | tartaric acid | 5.0/5.0 | 2 |
| Example 2 | magnesium carbonate | vapor-phase silica | citric acid | 7.0/3.0 | 15 |
| Example 3 | basic cobalt carbonate | vapor-phase silica | adipic acid | 1.5/8.5 | 20 |
| Example 4 | basic nickel carbonate | colloidal silica | tannic acid | 9.0/1.0 | 5 |
| Example 5 | zirconium ammonium | colloidal silica | phytic acid | 6.0/4.0 | 40 |
| | carbonate | | | | |
| Example 6 | basic manganese | vapor-phase silica | glutamic acid | 4.0/6.0 | 25 |
| | carbonate | | | | |
| Comparative | zinc carbonate | vapor-phase silica | tartaric acid | 9.7/0.3 | 15 |
| Example 1 | | | | | |
| Comparative | basic calcium carbonate | colloidal silica | glutamic acid | 5.0/5.0 | 0.5 |
| Example 2 | | | | | |
| Comparative | iron carbonate | vapor-phase silica | citric acid | 3.0/7.0 | 65 |
| Example 3 | | | | | |

| | |
|---|---|
| Comparative | chromate solution |
| Example 4 | |

TABLE 2
Test results

| | Amount of film | Saline resistance | |
|---|---|---|---|
| | (mg/m²) | Saline immersion test | Cell reaction test |
| Example 1 | 200 | 100/100 | 100/100 |
| Example 2 | 300 | 100/100 | 100/100 |
| Example 3 | 50 | 100/100 | 100/100 |
| Example 4 | 1350 | 100/100 | 100/100 |
| Example 5 | 450 | 100/100 | 100/100 |
| Example 6 | 600 | 100/100 | 100/100 |
| Comparative | 200 | 70/100 | 20/100 |
| Example 1 | | | |
| Comparative | 500 | 50/100 | 5/100 |
| Example 2 | | | |
| Comparative | 350 | 25/100 | 15/100 |
| Example 3 | | | |
| Comparative | Cr: 70 | 100/100 | 100/100 |
| Example 4 | | | |

In the invention, saline resistance means that (1) the result of the saline immersion test is 90/100 or higher and (2) the result of the cell reaction test is.90/100 or higher. All Examples satisfying the requirements of the invention exhibit good evaluation results equal to or higher than those of Comparative Example 4 wherein chromate treatment was carried out. However, Comparative Examples 1 to 3 wherein films not satisfying the requirements of the invention were provided are significantly inferior in performance.

While the present invention has been described in detail and with reference to specific embodiments thereof, it will be apparent to one skilled in the art that various changes and modifications can be made therein without departing from the spirit and scope thereof.

The present application is based on Japanese Patent Application No. 2005-304448 filed on Oct. 19, 2005, and the contents thereof are incorporated herein by reference.

What is claimed is:

1. A gasket material comprising:
a steel plate;
a film comprising a reaction product of:
(A) a carbonate of at least one selected from the group consisting of Mg, Co, Zr, Mn, Ni, and Cu;
(B) a water-dispersible silica; and
(C) an organic acid containing at least one of a carboxyl group and a hydroxyl group in one molecule and having 3 to 10 carbon atoms in one molecule; and
a rubber layer disposed on at least one side of the steel plate via the film.

2. The gasket material according to claim 1,
wherein an amount ratio of the carbonate (A) to the water-dispersible silica (B) is 0.5/9.5 to 9.5/0.5 by weight.

3. The gasket material according to claim 1,
wherein an amount of the organic acid (C) is 1 to 50% by weight with respect to that of the carbonate (A).

4. The gasket material according to claim 1,
which further comprises a primer layer between the rubber layer and the film.

5. The gasket material according to claim 4,
wherein the primer layer comprises an adhesive comprising a nitrile rubber compound and a phenol resin.
